(19) United States
(12) Patent Application Publication
(10) Pub. No.: US 2020/0303983 A1
(43) Pub. Date: Sep. 24, 2020

(54) STATOR AND ROTATING ELECTRICAL MACHINE

(71) Applicant: FANUC CORPORATION, Yamanashi (JP)

(72) Inventor: Yasuo YAMADA, Yamanashi (JP)

(73) Assignee: FANUC CORPORATION, Yamanashi (JP)

(21) Appl. No.: 16/790,553

(22) Filed: Feb. 13, 2020

(30) Foreign Application Priority Data
Mar. 22, 2019 (JP) 2019-054836

(51) Int. Cl. H02K 3/28; H02K 1/12; H02K 15/02; H02K 5/16; H02K 3/46

(52) U.S. Cl. CPC H02K 3/28; H02K 1/12; H02K 3/46; H02K 5/161; H02K 15/02

(57) ABSTRACT

In one aspect of the present disclosure, a stator includes a substantially cylindrical iron core including a winding attached inside, and a stator frame joined to the iron core via a first weld portion. In the stator, the iron core includes a groove portion extending along an axial direction and recessed from an outer circumferential surface of the iron core inward in a radial direction, and the first weld portion is formed at, on at least one edge in the axial direction of the iron core, mutually facing portions of an edge portion of the iron core and an inner circumferential surface of the stator frame.

This application is based on and claims the benefit of priority from Japanese Patent Application No. 2019-054836, filed on 22 Mar. 2019, the content of which is incorporated herein by reference.

### BACKGROUND OF THE INVENTION

### Field of the Invention

The present invention relates to a stator and a rotating electrical machine including the stator.

### Related Art

In a rotating electrical machine including a rotor and a stator, the stator is configured with an iron core including a winding attached, and a stator frame attached to the outer surface of the stator. As one method of fixing the iron core to the stator frame, a method called shrink fitting is known (refer to, for example, Patent Document 1).
Patent Document 1: Japanese Unexamined Utility Model Application, Publication No. H07-9070

### SUMMARY OF THE INVENTION

In the above-described fixing by shrink fitting, the iron core and the stator frame are likely to be deformed, and thus magnetic characteristics may be deteriorated. Therefore, a stator and a rotating electrical machine having good magnetic characteristics are desired.

(1) In one aspect of the present disclosure, a stator includes a substantially cylindrical iron core including a winding attached inside, and a stator frame joined to the iron core via a first weld portion. In the stator, the iron core includes a groove portion extending along an axial direction and recessed from an outer circumferential surface of the iron core inward in a radial direction, and the first weld portion is formed at, on at least one edge in the axial direction of the iron core, mutually facing portions of an edge portion of the iron core and an inner circumferential surface of the stator frame.

(2) In another aspect of the present disclosure, a rotating electrical machine includes the stator according to (1) and a rotor disposed inside the stator and supported by a rotary shaft.

The one aspect of the present disclosure enables to provide a stator and a rotating electrical machine having good magnetic characteristics.

### BRIEF DESCRIPTION OF THE DRAWINGS

FIG. 1 is a cross-sectional view for explaining a configuration of an electric motor 1 according to one embodiment.

FIG. 2 is an oblique view of a stator 20.

FIG. 3 is an exploded oblique view of an iron core 21 and a stator frame 22 included in the stator 20.

FIG. 4A is a diagram for explaining the action generated at the time when the iron core 21 and the stator frame 22 are joined via a first weld portion W1.

FIG. 4B is a diagram for explaining the action generated after the iron core 21 and the stator frame 22 are joined via the first weld portion W1.

FIG. 5A is a diagram illustrating an example of a groove portion 212 of the iron core 21 joined via a second weld portion W2.

FIG. 5B is a diagram illustrating another example of the groove portion 212 of the iron core 21 joined via the second weld portion W2.

FIG. 6A is a diagram illustrating an example of each of the groove portions 212 disposed at every other position of teeth 211 of the iron core 21.

FIG. 6B is a diagram illustrating an example of each of the groove portions 212 disposed at a position between adjacent teeth 211 of the iron core 21.

FIG. 7A is a diagram illustrating an example of the groove portions 212 having triangular shapes in the cross section.

FIG. 7B is a diagram illustrating an example of the groove portions 212 having substantially U shapes in the cross section.

### DETAILED DESCRIPTION OF THE INVENTION

One embodiment of the present disclosure will be described below. All of the drawings attached to the present specification are schematic diagrams, and a shape, a scale, a length/width ratio and the like of each part are changed from the actual ones or exaggerated, so as to be easily understood. In the drawings, hatching of indicating a cross section of a member will be omitted as appropriate.

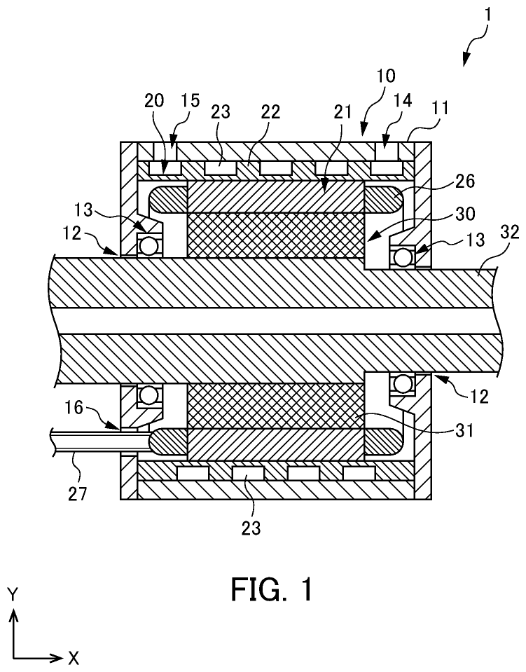

The electric motor 1 (rotating electrical machine) including the stator 20 of the present embodiment is described first. FIG. 1 is a cross-sectional view for explaining the configuration of the electric motor 1 according to the one embodiment. It is noted that the configuration of the electric motor 1 shown in FIG. 1 is merely one example, and any configuration is available as long as the stator 20 of the present embodiment is available.

In each of FIG. 1 and other drawings, a coordinate system including the X axis and the Y axis orthogonal to each other is illustrated. In the present coordinate system, the X direction serves as the axial direction of the electric motor 1, the Y direction serves as the radial direction thereof, and the R direction serves as the circumferential direction thereof. It is noted that the axial direction, the radial direction and the circumferential direction of the electric motor 1 respectively coincide with the axial directions, the radial directions and the circumferential directions of the stator 20, the iron core 21 and the stator frame 22, which are described below.

As shown in FIG. 1, the electric motor 1 includes a frame 10, the stator 20 and a rotor 30. The frame 10, which is an exterior member of the electric motor 1, includes a frame body 11, a shaft hole 12 and a bearing 13. The frame body 11 is a housing for enclosing and holding the stator 20. The frame body 11 holds the rotor 30 via the bearing 13. The frame body 11 includes a supply port 14, a discharge port 15 and a hole part 16. The supply port 14 is an opening for supplying a refrigerant to a passage 23 (to be described below) of the stator frame 22, and is connected to a supply pipe (not shown) of the refrigerant. The discharge port 15 is an opening for discharging the refrigerant circulated through the passage 23, and is connected to a discharge pipe (not shown) of the refrigerant. The hole part 16 is an opening through which a power line 27 drawn out from the iron core 21 pierces. The shaft hole 12 is a hole through which a rotary shaft 32 (to be described below) pierces. The bearing 13 is a member for rotatably supporting the rotary shaft 32.

The stator 20 is a composite member configured to form a rotating magnetic field for rotating the rotor 30. The stator 20 is formed in a cylindrical shape as a whole, and is fixed inside the frame 10. The stator 20 includes the iron core 21 and the stator frame 22.

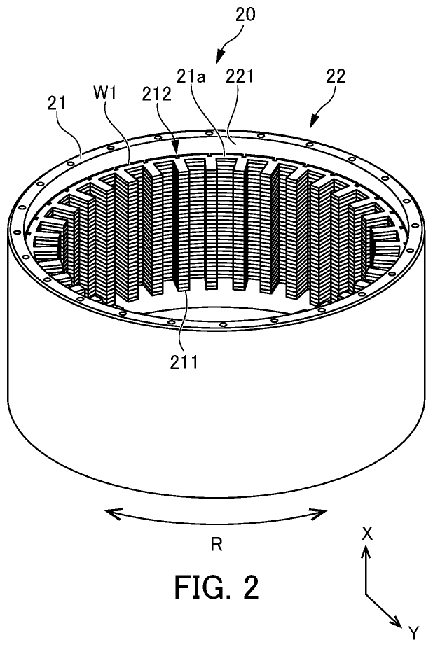

The iron core 21 is a member allowing a winding 26 to be attached inside. The iron core 21 is formed in a cylindrical shape, and is disposed inside the stator frame 22 in the stator 20. The iron core 21 has a plurality of the teeth 211 (refer to FIG. 2) on the inner surface thereof. The winding 26 is attached to the teeth 211. It is noted that the winding 26 partially protrudes from the both ends of the iron core 21 in the axial direction (X direction) of the iron core 21. The iron core 21 is integrated by, for example, laminating a plurality of thin plates such as electromagnetic steel plates to form a laminated body, and joining the laminated body such as by bonding, bolting or calking.

The stator frame 22 is a member for holding the iron core 21 inside thereof. The stator frame 22 is formed in a cylindrical shape. As will be described below, the iron core 21 is joined to the stator frame 22 via a weld portion (not shown). As shown in FIG. 1, the stator frame 22 of the present embodiment includes, on the outer surface, the passage 23 for cooling the heat transmitted from the iron core 21. The passage 23 is a single or multiple spiral groove(s) formed on the outer surface of the stator frame 22. The refrigerant (not shown) supplied through the supply port 14 of the frame body 11 (frame 10) circulates through the passage 23 spirally along the outer surface of the stator frame 22, and thereafter is discharged to the outside through the discharge port 15 of the frame body 11.

Examples of the material for the stator frame 22 include carbon steel, a steel member for electromagnetic steel plate, and stainless steel. It is noted that the stator frame 22 may be made of any material as long as the stator frame 22 is able to be welded to the iron core 21. The inner circumferential side of the stator frame 22 to be joined to the iron core 21 by welding may be made of iron material, and the outer circumferential side thereof may be made of non-iron material.

The power line 27 electrically connected to the winding 26 is drawn out from the iron core 21 of the stator 20. The power line 27 is connected to a power supply (not shown) installed outside the electric motor 1. In an example, during when the electric motor 1 operates, a three-phase alternating current is supplied to the iron core 21, thereby forming a rotating magnetic field for rotating the rotor 30.

The rotor 30 is a component configured to be rotated by magnetic interaction with the rotating magnetic field formed by the stator 20. The rotor 30 is disposed inside the stator 20. The rotor 30 includes a rotor body 31 and the rotary shaft 32. The rotor body 31 is configured with a plurality of permanent magnets (not shown), to generate a rotational force by the rotating magnetic field formed by the stator 20.

The rotary shaft 32 is a member for supporting the rotor body 31. The rotary shaft 32 is inserted so as to pierce through the axial center of the rotor body 31, and is fixed to the rotor body 31. The rotary shaft 32 is rotatably supported by the bearing 13 provided in the frame 10. The rotary shaft 32 pierces through the shaft hole 12, and is connected to a power transmission mechanism, a speed reduction mechanism and the like (not shown) disposed outside.

In the electric motor 1 shown in FIG. 1, when a three-phase alternating current is supplied to the stator 20 (iron core 21), the magnetic interaction generated between the stator 20 and the rotor 30 where the rotating magnetic field is formed generates a rotational force to the rotor body 31, and the rotational force is output to the outside via the rotary shaft 32. It is noted that although the electric motor 1 is a synchronous motor in the present embodiment, the electric motor 1 may be, for example, an induction motor.

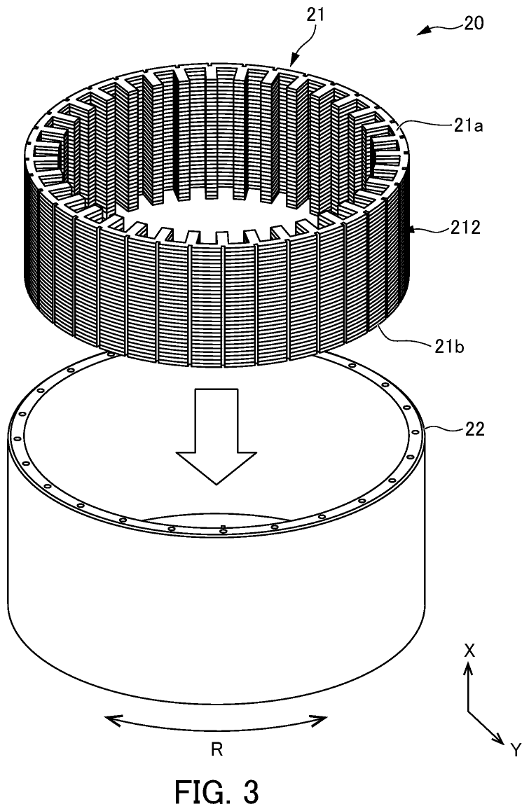

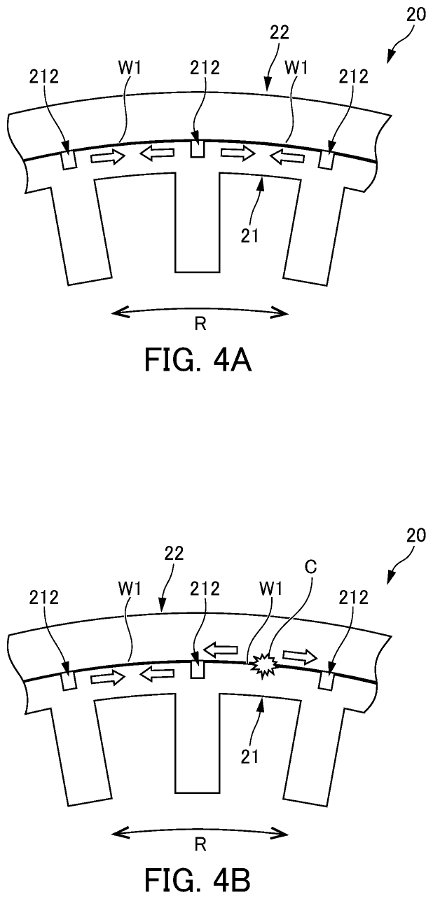

The stator 20 in the electric motor 1 of the present embodiment is described next. In the drawings of the embodiment to be described below, the illustration of the winding 26 attached to the teeth 211 of the iron core 21, the passage 23 provided on the outer surface of the stator frame 22, and the like are omitted. FIG. 2 is an oblique view of the stator 20. FIG. 3 is an exploded oblique view of the iron core 21 and the stator frame 22 included in the stator 20. FIG. 4A is a diagram for explaining the action generated at the time when the iron core 21 and the stator frame 22 are joined via the first weld portion W1. FIG. 4B is a diagram for explaining the action generated after the iron core 21 and the stator frame 22 are joined via the first weld portion W1. Each of FIG. 4A and FIG. 4B is a plan view of a part of the stator 20 shown in FIG. 2 viewed from the axial direction (X direction), as an example.

As shown in FIG. 2, in the stator 20, the iron core 21 is held inside the stator frame 22 in the radial direction (Y direction). The iron core 21 has the plurality of teeth 211 on the inner surface thereof, which are disposed away from one another in the circumferential direction (R direction) and protrude inward in the radial direction (Y direction). The winding 26 (refer to FIG. 1) is attached to gaps between teeth 211, 211 adjacent in the circumferential direction (R direction).

The iron core 21 has, on the outer circumferential surface thereof, the plurality of groove portions 212 recessed from the outer circumferential surface inward in the radial direction. The groove portions 212 are disposed at the positions corresponding to the teeth 211 of the iron core 21. In the present embodiment, each of the groove portions 212 is disposed at a center in the circumferential direction (R direction) of each of the root portions of the teeth 211. As shown in FIG. 3, each of the groove portions 212 is disposed from one edge portion 21a through to the other edge portion 21b in the axial direction (X direction) of the iron core 21.

As shown in FIG. 2, the iron core 21 inserted in the stator frame 22 is joined at the mutually facing portions of the edge portion 21a and an inner circumferential surface 221 of the stator frame 22 via the first weld portion W1. The groove portions 212 of the iron core 21 are not joined to the stator frame 22 via the first weld portion W1. The first weld portion W1 is formed by joining the mutually facing portions of the edge portion 21a of the iron core 21 and the internal circumferential surface 221 of the stator frame 22 by, for example, laser welding.

The iron core 21 is joined also at the mutually facing portions of the edge portion 21b not shown of the iron core 21 positioned opposite to the edge portion 21a and the inner circumferential surface 221 of the stator frame 22 via the first weld portion W1. That is, the iron core 21 of the present embodiment is joined to the stator frame 22 via the first weld portion W1 at the edge portion 21a and the edge portion 21b respectively in the axial direction (X direction).

As shown in FIG. 4A, when the iron core 21 and the stator frame 22 are joined via the first weld portion W1, the iron core 21 is distorted in the illustrated arrow directions by the heat of welding. The distortion is dispersed by the groove portions 212 disposed on the outer circumferential surface of the iron core 21, thereby enabling to suppress the deterioration in magnetic characteristics caused by the deformation of the iron core 21. If the whole circumferences of the mutually facing portions of the edge portion 21a (21b) of the iron core 21 without the groove portions 212 provided and the internal circumferential surface 221 of the stator frame 22 are welded to each other, the distortion caused in the iron core 21 is not dispersed, unlike in FIG. 4A. For this reason, the deformation of the iron core 21 may deteriorate the magnetic characteristics. In the stator 20 of the present embodiment, the mutually facing portions of the edge portion 21a (21b) of the iron core 21 except the groove portions 212 provided on the outer circumferential surface of the iron core 21 and the inner circumferential surface 221 of the stator frame 22 are joined via the first weld portion W1, thereby enabling to suppress the deterioration in magnetic characteristics caused by the deformation of the iron core 21.

It is assumed that, as shown in FIG. 4B, after the iron core 21 and the stator frame 22 are joined via the first weld portion W1, a crack C is generated partially in the first weld portion W1. It is conceivable that the crack C propagates in one of or both directions of the illustrated arrows, but in either case, the propagation is suppressed by the groove portions 212 disposed in the vicinity. Accordingly, in the stator 20 of the present embodiment, even in the case where the crack C is generated partially in the first weld portion W1, the crack C is prevented from propagating in a wide range. If the whole circumferences of the mutually facing portions of the edge portion 21a (21b) of the iron core 21 without the groove portions 212 provided and the internal circumferential surface 221 of the stator frame 22 are welded to each other, the crack C is not able to be suppressed from propagating, and accordingly the crack C has possibility of propagating in a wide range. However, since the stator 20 of the present embodiment includes the groove portions 212 on the outer circumferential surface of the iron core 21, the crack C generated in the first weld portion W1 is able to be suppressed from propagating.

In the stator 20 of the present embodiment described above, the iron core 21 and the stator frame 22 are hardly deformed as compared with the case of fixing by shrink fitting, and accordingly the stator 20 has better magnetic characteristics. In addition, the iron core 21 is able to be more easily fitted into the stator frame 22, as compared with the case of fixing by shrink fitting.

As a method of fixing an iron core to a stator frame, joining with an adhesive is known. However, in the joining with an adhesive, the adhesive strength depends on the surface conditions of the iron core and the stator frame, and the gaps between the iron core and the stator frame need to be controlled uniformly. On the other hand, in the stator 20 of the present embodiment, the joining strength of the first weld portion W1 less depends on the surface conditions of the iron core 21 and the stator frame 22, and the accuracy of the gaps between the iron core 21 and the stator frame 22. Therefore, in the stator 20 of the present embodiment, the iron core 21 and the stator frame 22 are able to be joined more stably.

As another method of fixing an iron core to a stator frame, key engagement is known. However, in the key engagement, since a key groove needs to be provided on a stator frame, the number of machining steps increases. On the other hand, in the stator 20 of the present embodiment, a step such as of providing a key groove on the stator frame 22 is not required, and thus the number of machining steps is able to be suppressed.

In the stator 20 of the present embodiment, the groove portions 212 of the iron core 21 are disposed from the one edge portion 21a through to the other edge portion 21b in the axial direction (X direction) of the iron core 21. Therefore, when the iron core 21 and the stator frame 22 are joined via the first weld portion W1, the distortion occurring in the iron core 21 is able to be dispersed in a wider range. It is noted that the groove portions 212 may not be disposed through between the both edge portions in the axial direction of the iron core 21. In an example, the groove portions 212 may be disposed in the vicinity of the one edge portion 21a in the axial direction of the iron core 21, and in the vicinity of the other edge portion 21b, respectively.

In the stator 20 of the present embodiment, each of the groove portions 212 of the iron core 21 is disposed at a center of each of the root portions of the teeth 211. It is conceivable that, in the iron core 21, the portion where each of the groove portions 212 is arranged has less magnetic fluxes passing through the inside thereof. However, each of the groove portions 212 is disposed at a center of each of the root portions of the teeth 211 where the magnetic fluxes easily pass, thereby enabling to minimize the influence caused by the decrease of the magnetic fluxes. It is noted that, as will be described below, the positions where the groove portions 212 are disposed in the iron core 21 may be other positions than the root portions of the teeth 211.

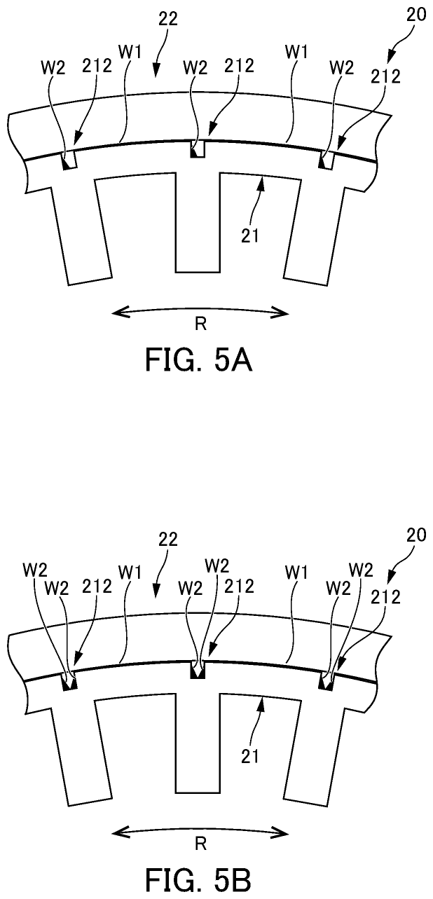

Another embodiment of the iron core 21 is described next. Each of FIG. 5A and FIG. 5B is a diagram illustrating an example of each of the groove portions 212 of the iron core 21 joined via the second weld portion W2. Each of FIG. 5A and FIG. 5B is a plan view of a part of the iron core 21 viewed from the axial direction (X direction). As described above, the iron core 21 is integrated by laminating a plurality of thin plates such as electromagnetic steel plates to form a laminated body, and joining the laminated body such as by bonding, bolting or calking. In the present example to be described below, the iron core 21 is integrated by welding the groove portions 212 of the iron core 21.

In the iron core 21 shown in FIG. 5A, one corner (the left side in the drawing) on the bottom surface side of each of the groove portions 212 is joined via the second weld portion W2. The second weld portion W2 is disposed from the one edge portion 21a through to the other edge portion 21b in the axial direction (X direction) of the iron core 21 serving as a laminated body (refer to FIG. 3). It is noted that, in the iron core 21 shown in FIG. 5A, the other corner (the right side in the drawing) on the bottom surface side of each of the groove portions 212 may be joined via the second weld portion W2.

In the iron core 21 shown in FIG. 5B, the both corners on the bottom surface side of each of the groove portions 212 are respectively joined via the second weld portions W2. Also in the present aspect, each of the second weld portions W2 is disposed from the one edge portion 21a through to the other edge portion 21b in the axial direction of the iron core 21 serving as a laminated body. The iron core 21 is joined by the method shown in FIG. 5A or FIG. 5B, thereby enabling to integrate more firmly the laminated body formed by laminating a plurality of thin plates such as electromagnetic steel plates.

The one embodiment of the present disclosure has been described so far. The present disclosure is not limited to the above-described embodiment. Various modifications and changes are available as in the modifications to be described below. Such modifications and changes are also within the technical scope of the present disclosure. The above effects in the embodiment are described merely as the most preferable effects generated by the present disclosure. The effects generated by the present disclosure are not limited to those described in the embodiment. It is noted that although the above-described embodiment and the modifications to be described below are available in any combination thereof, the detailed description will be omitted.

(Modifications)

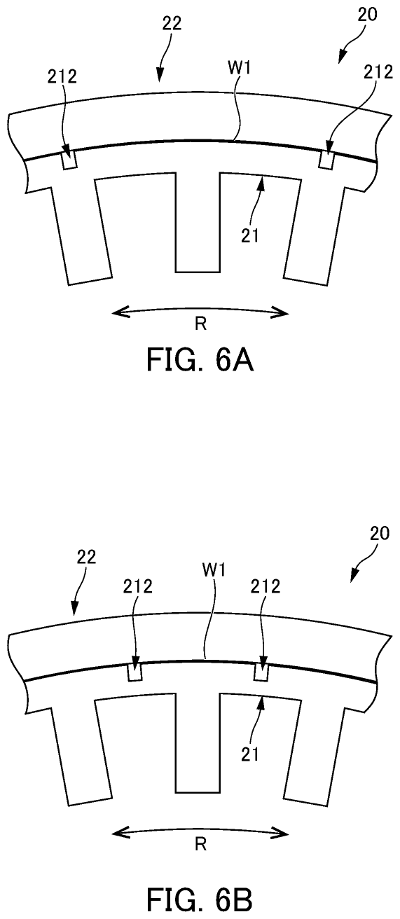

FIG. 6A is a diagram illustrating the example of each of the groove portions 212 disposed at every other position of the teeth 211 of the iron core 21. FIG. 6B is a diagram illustrating the example of each of the groove portions 212 disposed at a position between teeth 211 adjacent in the circumferential direction (R direction) of the iron core 21. Each of FIG. 6A and FIG. 6B is a plan view of a part of the iron core 21 viewed from the axial direction (X direction). As shown in FIG. 6A, each of the groove portions 212 may be disposed at every other position in the circumferential direction of the teeth 211 of the iron core 21. Also in this case, each of the groove portions 212 is disposed at a center in the circumferential direction of each of the root portions of the teeth 211. It is noted that in the case of the iron core 21 having a large diameter, each of the groove portions 212 may be disposed at every third position or more in the circumferential direction of the teeth 211 of the iron core 21.

As shown in FIG. 6B, each of the groove portions 212 may be disposed at a position between teeth 211 adjacent in the circumferential direction (R direction) of the iron core 21. Although, in the example shown in FIG. 6B, each of the groove portions 212 is disposed at an intermediate position of adjacent teeth 211 of the iron core 21, the present invention is not limited thereto. Each of the groove portions 212 may be disposed close to one of adjacent teeth 211 of the iron core 21 therebetween. Alternatively, a plurality of groove portions 212 may be disposed between adjacent teeth 211 of the iron core 21. The configuration shown in FIG. 6B may be combined with, for example, the configuration in which each of the groove portions 212 is disposed at a center of each of the root portions of the teeth 211.

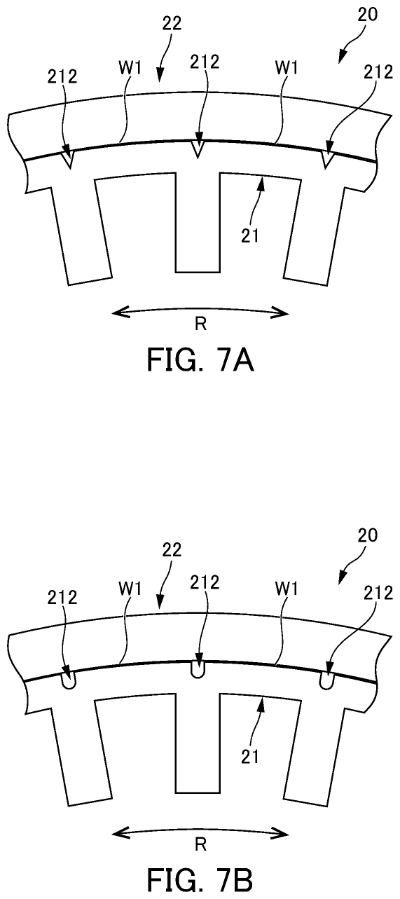

FIG. 7A is a diagram illustrating the example of the groove portions 212 having triangular shapes in the cross section. FIG. 7B is a diagram illustrating the example of the groove portions 212 having substantially U shapes in the cross section. Each of FIG. 7A and FIG. 7B is a plan view of a part of the iron core 21 viewed from the axial direction (X direction). As shown in FIG. 7A, the groove portions 212 may be formed in triangular shapes in the cross section. Alternatively, as shown in FIG. 7B, the groove portions 212 may be formed in substantially U shapes in the cross section. In the case of the groove portions 212 having substantially U shapes in the cross section as shown in FIG. 7B, when the iron core 21 and the stator frame 22 are joined via the first weld portion W1, the stress caused by heat hardly concentrates on the corners of the bottom surface sides of the groove portions 212. Therefore, the distortion of the iron core 21 caused by the heat of welding is able to be suppressed more effectively. It is noted that the cross sectional shape of the groove portions 212 is not limited to a triangular shape or a substantially U shape, and may be, for example, a semicircular shape or a semielliptical shape.

In the configuration of the iron core 21 of the present embodiment, either the mutually facing portions of the edge portion 21a and the inner circumferential surface 221 of the stator frame 22 or the mutually facing portions of the edge portion 21b and the inner circumferential surface 221 of the stator frame 22 may be joined via the first weld portion W1. The insides of the groove portions 212 may be filled with resin. Also in the case of such a configuration, the crack generated in the first weld portion W1 is able to be suppressed from propagating.

### EXPLANATION OF REFERENCE NUMERALS

1: ELECTRIC MOTOR, 20: STATOR, 21: IRON CORE, 22: STATOR FRAME, 211: TOOTH, 212: GROOVE PORTION, 221: INNER CIRCUMFERENTIAL SURFACE (STATOR FRAME), W1: FIRST WELD PORTION, W2: SECOND WELD PORTION

What is claimed is:

1. A stator comprising:
an iron core formed in a substantially cylindrical shape, the iron core including a winding attached inside; and
a stator frame joined to the iron core via a first weld portion, wherein
the iron core includes a groove portion extending along an axial direction and recessed from an outer circumferential surface of the iron core inward in a radial direction, and
the first weld portion is formed at, on at least one edge in the axial direction of the iron core, mutually facing portions of an edge portion of the iron core and an inner circumferential surface of the stator frame.

2. The stator according to claim 1, wherein
the groove portion extends from one edge through to the other edge in the axial direction of the iron core.

3. The stator according to claim 1, wherein
the groove portion is disposed at a position corresponding to a tooth protruding inward in the radial direction of the iron core.

4. The stator according to claim 1, wherein
the iron core is a laminated body formed by laminating a plurality of thin plates, and
the groove portion is joined via a second weld portion formed inside the groove portion, along the axial direction of the iron core.

5. A rotating electrical machine comprising:
the stator according to claim 1; and
a rotor disposed inside the stator and supported by a rotary shaft.
